(19) United States
(12) Patent Application Publication
(10) Pub. No.: US 2024/0351371 A1
(43) Pub. Date: Oct. 24, 2024

(54) WHEEL UNIT FOR A PEDELEC AND PEDELEC

(71) Applicant: SRAM, LLC, CHICAGO, IL (US)

(72) Inventors: KAI VENHOFF, RHEDE (DE); CHRISTIAN WURMBAECK, JESBERG (DE)

(73) Assignee: SRAM, LLC, CHICAGO, IL (US)

(21) Appl. No.: 18/685,505

(22) PCT Filed: Aug. 24, 2021
(86) PCT No.: PCT/EP2021/073383

§ 371 Date: Feb. 22, 2024

(51) Int. Cl. B60B 27/00; B60T 8/17

(52) U.S. Cl. CPC B60B 27/0068; B60B 27/0052; B60T 8/1706; B60Y 2200/13

(57) ABSTRACT

A wheel unit for a pedelec includes a hub and a rim connected via spokes which rotate about a rotational axis, a brake disc non-rotatably connected to the hub via a fastening device, and a sensor ring. The fastening device includes a mounting element non-rotatably arranged on the hub, and a clamping nut fastenable to the hub or to the mounting element via a screw connection. The brake disc is interlockingly connected to the mounting element in a direction of rotation. The brake disc is clampingly attached via the clamping nut in the direction of the rotational axis between the hub or the mounting element and the clamping nut. The sensor ring is connected rotationally fixed to the hub and is fixed to the clamping nut. The sensor ring is fastenable together with the clamping nut to the hub or to the mounting element via the screw connection.

### CROSS REFERENCE TO PRIOR APPLICATIONS

This application is a U.S. National Phase application under 35 U.S.C. § 371 of International Application No. PCT/EP2021/073383, filed on Aug. 24, 2021. The International Application was published in German on Mar. 2, 2023 as WO 2023/025371 A1 under PCT Article 21(2).

### FIELD

The present invention relates to a wheel unit for a pedelec. The present invention also relates to a pedelec.

### BACKGROUND

Such wheel units are known from the prior art. Both ordinary bicycles and pedelecs usually have a front wheel unit and a rear wheel unit, wherein both wheel units comprise a hub and a rim. The hub is connected to the rim via a large number of spokes, wherein the hub is used to rotatably mount the wheel unit to the frame, and the rim is used to hold a tire. The wheel units also comprise a brake, wherein the brake is often configured as a disc brake. The disc brakes usually comprise a brake disc attached to the hub, a brake caliper with two brake pads facing each other, and a brake lever arranged on a handlebar, wherein the brake pads are displaced towards each other by actuating the brake lever and the brake disc arranged between the two brake pads is clamped by the brake pads with their brake linings. The brake caliper is usually attached to the frame. The brake disc is usually attached to the hub via a fastening device. The fastening device can be attached to the hub according to a so-called center-lock principle, wherein a mounting element is provided on the hub and comprises means on its outer circumferential surface for interlockingly connecting to the brake disc in the direction of rotation. The brake disc has a through bore, which comprises counter means on its circumferential surface for interlockingly connecting with the means provided on the mounting element. The brake disc is thereby interlockingly attached to the hub in the direction of rotation, wherein the brake disc is pushed onto the mounting element in the direction of the rotational axis of the hub. The fastening device also comprises a clamping nut which is screwed into the mounting element or into the hub, wherein the brake disc is clamped between the mounting element and the clamping nut when the clamping nut is screwed in and is thereby fixed in the direction of the rotational axis of the hub. A fastening device of this type is described, for example, in DE 602 15 275 T3.

In contrast to a bicycle, one of the two wheel units in a pedelec is driven by an electric drive unit in addition to the rider's drive power. The electric drive unit can be integrated in the front or rear wheel unit, which is also referred to as a hub drive, or arranged in the area of a pedal crankshaft, wherein such an electric drive unit is also referred to as a mid-motor. It is necessary in all versions of the electric drive unit to determine a travelling speed of the pedelec, wherein the travelling speed is shown on a display of an operating unit and is also absolutely necessary for controlling an electric motor of the electric drive unit. Pedelecs may only be operated up to a legally permissible speed, i.e., the assistance provided by the electric drive unit may only be provided up to a legally prescribed maximum speed, wherein the electric drive unit must be switched off if the maximum speed is exceeded. Such a prescribed maximum speed is, for example, 25 km/h for conventional pedelecs and 45 km/h for so-called speed pedelecs.

In order to measure the riding speed, each pedelec comprises a speed sensor which measures the riding speed of the pedelec, wherein the sensor signals of the speed sensor are transmitted to a motor control unit which is used to control the electric motor. DE 10 2015 120 656 A1 describes, for example, such a pedelec with a speed sensor. The speed sensor described in DE 10 2015 120 656 A1 interacts with a sensor ring which comprises a sensing area and is attached to the brake disc, i.e., is arranged in contact with the brake disc. The sensor ring is screwed to the hub together with the brake disc. A disadvantage of such an arrangement and configuration of the sensor ring is that the sensor ring is directly exposed to the heat generated during braking, which could falsify the sensor signals of the speed sensor. Such an attachment of the sensor ring in combination with the attachment of the brake disc according to the center-lock principle is also not possible because the screw section of the clamping nut is so short that a sensor ring cannot be arranged between the clamping nut and the brake disc, a reliable attachment of the brake disc cannot otherwise be provided.

### SUMMARY

An aspect of the present invention is to provide a wheel unit comprising a brake disc and a sensor ring, wherein the brake disc and the sensor ring can be attached to the hub in a simple, cost-effective and reliable manner.

In an embodiment, the present invention provides a wheel unit for a pedelec. The wheel unit includes a hub which is rotatable about a rotational axis, a rim which is rotatable about the rotational axis, a fastening device, a brake disc, and a sensor ring. The hub and the rim are connected to one another via spokes. The fastening device comprises a mounting element which is non-rotatably arranged on the hub, and a clamping nut which is fastenable to the hub or to the mounting element via a screw connection. The brake disc is non-rotatably connected to the hub via the fastening device. The brake disc is interlockingly connected to the mounting element in a direction of rotation. The brake disc is clampingly attached via the clamping nut in the direction of the rotational axis between the hub or the mounting element and the clamping nut. The sensor ring is connected to the hub in a rotationally fixed manner. The sensor ring comprises a scanning area which is scannable by a speed sensor. The sensor ring is arranged to be directly fixed to the clamping nut. The sensor ring is fastenable together with the clamping nut to the hub or to the mounting element via the screw connection.

### BRIEF DESCRIPTION OF THE DRAWINGS

The present invention is described in greater detail below on the basis of embodiments and of the drawings in which:

FIG. 1 shows a schematic representation of a pedelec;

FIG. 2 shows a fastening device for attaching a brake disc to a hub of a pedelec from FIG. 1 in a frontal view; and

FIG. 3 shows the fastening device from FIG. 2 in a side view and in an exploded view.

### DETAILED DESCRIPTION

The wheel unit comprises a hub and a rim, the hub and the rim being connected to each other by a plurality of radially extending spokes. The hub is mounted on a section of the frame of a pedelec so that it can rotate about a rotational axis, thereby enabling movement of the pedelec and a rolling of the wheel unit on a road surface.

In order to provide for a safe riding operation of the pedelec, the pedelec comprises a brake. The brake comprises a brake disc provided on the wheel unit, which in turn interacts with a brake caliper attached to the frame. The wheel unit comprises a fastening device for attaching the brake disc to the hub so that a brake disc cannot rotate. The fastening device comprises a mounting element arranged on the hub in a non-rotatable manner, onto which the disc brake can be attached, wherein the mounting element can also be configured in one piece with the hub. The mounting element comprises an element and the brake disc comprises a counter element for the interlocking connection between the mounting element and the brake disc, via which the brake disc is connected to the mounting element in a torque-transmitting manner in the direction of rotation in a mounted state. The fastening device further comprises a clamping nut which can be attached to the hub or to the mounting element via a screw connection, wherein the brake disc is clamped by the clamping nut in the direction of the rotational axis between the hub and the clamping nut. The clamping nut and the mounting element each comprise a radial projection, wherein the brake disc is in contact with the radial projection of the mounting element in the direction of the rotational axis of the hub when mounted on the mounting element. In a final assembled state of the clamping nut, i.e., in a screwed-in state of the clamping nut, the brake disc is in contact with the radial projection of the clamping nut with a side facing away from the radial projection of the mounting element, wherein the clamping nut is screwed in until the brake disc is clamped between the two radial projections in the direction of the rotational axis.

The wheel unit has a sensor ring comprising a scanning area to determine the travelling speed of the pedelec. The scanning area is scanned by a speed sensor which is arranged on the frame, and the travelling speed is determined therefrom.

According to the present invention, the sensor ring is directly fixed to the clamping nut, wherein the sensor ring is attached together with the clamping nut to the hub or to the mounting element via the screwed connection of the clamping nut. The sensor ring can be attached to the clamping nut in a pre-assembly process and automatically attached to the hub during the brake disc assembly process. This can simplify the assembly process of the pedelec.

The fact that the sensor ring is attached to the clamping nut means that the sensor ring can be attached to the hub in a simple and reliable manner, wherein the attachment of the sensor ring does not negatively affect the attachment of the brake disc.

In an embodiment of the present invention, the sensor ring can, for example, be screwed to the clamping nut. The sensor ring comprises a circular ring-shaped section on which the scanning area is provided. Starting from the circular ring-shaped section, several fastening sections extend radially inwards, wherein the fastening sections are screwed to the clamping nut at their free ends. The screw connection of the sensor ring provides that the sensor ring is detachably attached to the clamping nut, which means that the sensor ring can be easily replaced if it is damaged or bent, for example, by a stone or other object hitting the sensor ring.

The sensor ring can, for example, be attached to the clamping nut via a press connection, wherein the sensor ring comprises at least one recess which forms a press connection with a protrusion provided on the clamping nut. The sensor ring comprises a circular ring-shaped section on which the scanning area is provided. Starting from the circular ring-shaped section, several fastening sections extend radially inwards, wherein a recess is formed on each of the fastening sections. The sensor ring and the clamping nut are manufactured separately from each other in separate manufacturing steps and then pressed together. The press connection is a connection that is reliable against loosening so that the sensor ring can be reliably attached to the clamping nut.

In an embodiment of the present invention, the sensor ring can, for example, be configured in one piece with the clamping nut, which can reduce the assembly effort of the wheel unit.

The brake disc can, for example, comprise an internal toothing and the mounting element can, for example, comprise an external toothing that corresponds to the internal toothing. This allows the brake disc to be reliably attached to the mounting element in the direction of rotation, wherein the toothing provides a relatively high torque transmission surface.

In an embodiment of the present invention, the clamping nut can, for example, comprise an anti-loss toothing on a side facing the mounting element, and the brake disc can, for example, comprise an anti-loss toothing on a side facing the clamping nut, wherein the anti-loss toothing of the clamping nut interacts with the anti-loss toothing of the brake disc. In the final assembled state of the clamping nut, the anti-loss toothing of the clamping nut interacts with the anti-loss toothing of the brake disc, whereby the teeth of the anti-loss toothing engage behind each other in the direction of rotation. This reduces the risk of loosening the screw connection between the clamping nut and the hub or the mounting element.

The clamping nut can, for example, comprise a bore, wherein a tool coupling structure is provided on the circumferential surface of the bore of the clamping nut. A tool coupling structure can alternatively be provided on the outer circumferential surface of the clamping nut. This allows the clamping nut to be mounted easily, reliably, and with a sufficiently high tightening torque so that a loosening of the screw connection between the clamping nut and the hub or the mounting element can be reliably prevented.

A center plane of the sensor ring and a center plane of the brake disc can, for example, be arranged to be offset with respect to each other.

The present invention also provides a pedelec with a wheel unit and a speed sensor, wherein the speed sensor interacts with the sensor ring. The advantages thereof are described above.

Such a configuration of the wheel unit allows the sensor ring to be attached to the hub in a simple and reliable manner, wherein the attachment of the sensor ring does not negatively affect the attachment of the brake disc. The sensor ring can in particular be mounted in combination with the mounting of the brake disc according to the CenterLock principle, wherein the time required for mounting the wheel unit is reduced by simply attaching the brake disc to the mounting element and screwing in the clamping nut.

An embodiment of the present invention is described in greater detail below with reference to the drawings.

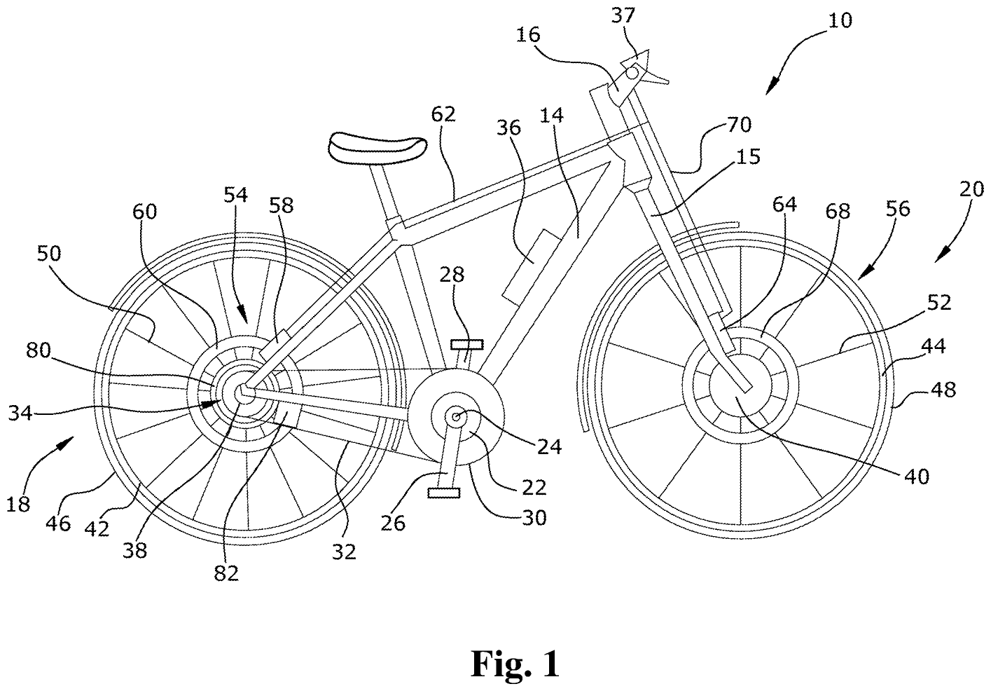

FIG. 1 shows a pedelec 10 with a frame 14, a front wheel unit 20, and a rear wheel unit 18. The front wheel unit 20 is rotatably mounted on a fork 15, wherein the fork 15 is rotatably mounted on the frame 14 and is non-rotatably connected to a handlebar 16. Both wheel units 18, 20 each comprise a hub 38, 40 and a rim 42, 44, wherein each hub 38, 40 is connected to the rim 42, 44 via a plurality of spokes 50, 52. A tire 46, 48 is arranged on each of the rims 42, 44.

The pedelec 10 further comprises an electric drive unit 22, a traction battery 36 attached to the frame 14, and a control unit 37 attached to the handlebar 16. The electric drive unit 22 is configured as a center motor and is arranged in the region of a pedal crankshaft 24. The electric drive unit 22 comprises an electric motor and possibly a gearbox (which are not shown in FIG. 1). The electric motor is connected to a torque-transmitting output chainring 30 via the gearbox. The output chainring 30 is also connected to the pedal crankshaft 24, wherein a rider torque introduced into the pedal crankshaft 24 via two pedal cranks 26, 28 is transmitted to the output chainring 30. This means that a total drive power generated by the electric motor and a rider power input by the rider is available at the output chainring 30. The output chainring 30 is connected via a chain 32 to a pinion cassette 34 which is attached to the hub 38 of the rear wheel unit 18 in a torque-transmitting manner so that the rear wheel unit 18 is driven by the motor power and the rider power.

In order to provide a safe riding operation of the pedelec 10, disc brakes 54, 56 are provided on each of the two wheel units 18, 20. The disc brakes 54, 56 each comprise a brake caliper 58, 64 attached to the frame 14 and a brake disc 60, 68 attached to the hub 38, 40. The brake calipers 58, 64 each comprise two brake pads which clamp the brake disc 60, 68 during a braking operation and are each connected via a hydraulic brake line 62, 70 to a brake lever arranged on the handlebar 16.

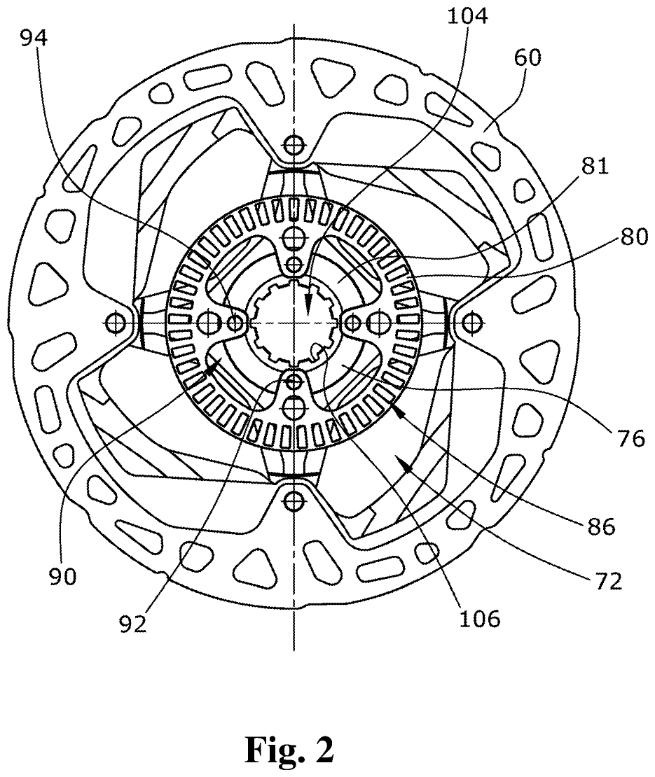

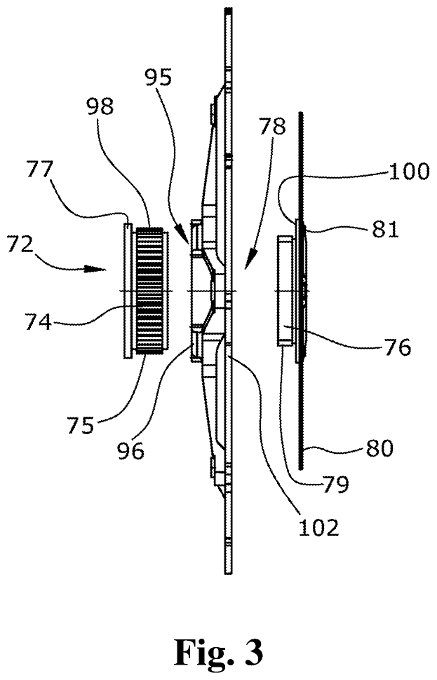

The brake discs 60, 68 are each non-rotatably connected to the hub 38, 40 of the wheel units 18, 20 via a fastening device 72. One such fastening device 72 is shown in FIGS. 2 and 3. The fastening device 72 comprises a mounting element 74 which is attached to the hub 38, 40. The mounting element 74 is configured in the form of a sleeve and comprises a brake disc fastening area 75 on an outer circumferential surface. The brake disc fastening area 75 comprises an external toothing 98 which interacts with an internal toothing 96 of the brake disc 60, 68 in the mounted state. An internal thread, which is not visible in the drawings, is provided on an inner circumferential surface of the sleeve-like mounting element 74. The mounting element 74 comprises a radial projection 77 on an axial side facing the hub 38, 40. The fastening device 72 also has a clamping nut 76, which comprises a fastening section 79 with an external thread, wherein the clamping nut 76 is screwed into the internal thread of the mounting element 74 via the external threads. In other words, the clamping nut 76 is connected to the mounting element 74 via a screw connection 78. The clamping nut 76 also comprises a radial projection 81.

When the brake disc 60, 68 is mounted on the hub 38, 40, the brake disc 60, 68, which comprises a bore 95 with an internal toothing 96, is pushed onto the brake disc fastening area 75, thereby connecting the brake disc 60, 68 to the mounting element 74 and the hub 38, 40 in a rotationally fixed manner via toothing 96, 98. The clamping nut 76 is then screwed into the mounting element 74, wherein the brake disc 60, 68 is clamped between the radial projection 77 of the mounting element 74 and the radial projection 81 of the clamping nut 76 in the direction of the rotational axis of the hub 38, 40, whereby the brake disc 60, 68 is fixed in the direction of the rotational axis of the hub 38, 40. The clamping nut 76 comprises an anti-loss toothing 100 on its surface which is in contact with the brake disc 60, 68, wherein the anti-loss toothing 100 interacts with a corresponding anti-loss toothing 102 provided on the brake disc 60, 68. This reduces the risk of the clamping nut 76 coming loose. A tool coupling structure 106 is provided on a bore 104 of the clamping nut 76 for mounting the clamping nut 76, wherein a tool can be interlockingly coupled to the clamping nut 76 in the direction of rotation via the tool coupling structure 106, and the screw connection 78 between the mounting element 74 and the clamping nut 76 can be tightened.

In order to operate the pedelec 10, i.e., to control an electric motor of the electric drive unit 22, it is imperative that the travelling speed of the pedelec 10 is measured. Pedelecs 10 may only be operated up to a legally permissible riding speed, i.e., assistance by the electric drive unit 22 may only be provided up to a legally prescribed maximum speed, wherein the electric drive unit 22 must be switched off if the maximum speed is exceeded.

In order to measure the travelling speed of the pedelec 10, the pedelec 10 comprises a speed sensor 82 which measures the travelling speed of the pedelec 10, wherein the sensor signals of the speed sensor 82 are transmitted to a motor control unit which is used to control the electric motor. The speed sensor 82 interacts with a sensor ring 80, which comprises a scanning area 86.

According to the present invention, the sensor ring 80 is fixedly arranged on the clamping nut 76. The sensor ring 80 has four fastening sections 90 distributed around the circumference which project radially inwards, each comprising a recess 92. The clamping nut 76 comprises four protrusions 94 corresponding to the recesses 92, wherein the fastening sections 90 with the recesses 92 are pushed onto the protrusions 94. This creates several press connections between the fastening sections 90 and the protrusions 94. The sensor ring 80 could alternatively be screwed to the clamping nut 76 or configured integrally with the clamping nut 76.

It should be clear that other constructive embodiments of the pedelec 10 compared to the described embodiment are also possible. Reference should be had to the appended claims.

### LIST OF REFERENCE NUMERALS

| | |
|---|---|
| 10 | Pedelec |
| 14 | Frame |
| 15 | Fork |
| 16 | Handlebar |
| 18 | Rear wheel unit |
| 20 | Front wheel unit |
| 22 | Electric drive unit |
| 24 | Pedal crankshaft |
| 26 | Pedal crank |
| 28 | Pedal crank |
| 30 | Output chainring |
| 32 | Chain |
| 34 | Pinion cassette |
| 36 | Traction battery |
| 37 | Control unit |
| 38 | Hub |
| 40 | Hub |
| 42 | Rim |
| 44 | Rim |
| 46 | Tire |
| 48 | Tire |
| 50 | Spoke |
| 52 | Spoke |
| 54 | Disc brakes |
| 56 | Disc brakes |
| 58 | Brake caliper |
| 60 | Brake disc |
| 62 | Hydraulic brake line |
| 64 | Brake caliper |
| 68 | Brake disc |
| 70 | Hydraulic brake line |
| 72 | Fastening device |
| 74 | Mounting element |
| 75 | Fastening area |
| 76 | Clamping nut |
| 77 | Radial projection |
| 78 | Screw connection |
| 79 | Fastening section |
| 80 | Sensor ring |
| 81 | Radial projection |
| 82 | Speed sensor |
| 86 | Scanning area |
| 90 | Fastening section |
| 92 | Recess |
| 94 | Protrusion |
| 95 | Bore |
| 96 | Internal toothing |
| 98 | External toothing |
| 100 | Anti-loss toothing |
| 102 | Anti-loss toothing |
| 104 | Bore |
| 106 | Tool coupling structure |

What is claimed is:

1-10 (canceled)

11. A wheel unit for a pedelec, the wheel unit comprising:
a hub which is rotatable about a rotational axis;
a rim which is rotatable about the rotational axis, the hub and the rim being connected to one another via spokes;
a fastening device comprising,
a mounting element which is non-rotatably arranged on the hub, and
a clamping nut which is fastenable to the hub or to the mounting element via a screw connection;
a brake disc which is non-rotatably connected to the hub via the fastening device, wherein,
the brake disc is interlockingly connected to the mounting element in a direction of rotation, and
the brake disc is clampingly attached via the clamping nut in the direction of the rotational axis between the hub or the mounting element and the clamping nut; and
a sensor ring which is connected to the hub in a rotationally fixed manner; the sensor ring comprising a scanning area which is scannable by a speed sensor,
wherein,
the sensor ring is arranged to be directly fixed to the clamping nut, and
the sensor ring is fastenable together with the clamping nut to the hub or to the mounting element via the screw connection.

12. The wheel unit as recited in claim 11, wherein the sensor ring is arranged on a side of the clamping nut which faces away from the brake disc.

13. The wheel unit as recited in claim 11, wherein the sensor ring is directly fixed to the clamping nut by being screwed to the clamping nut.

14. The wheel unit as recited in claim 11, wherein,
the sensor ring is directly fixed to the clamping nut via a press connection, and
the sensor ring further comprises at least one recess which forms the press connection via a corresponding protrusion provided on the clamping nut.

15. The wheel unit as recited in claim 11, wherein the sensor ring is configured in one piece with the clamping nut.

16. The wheel unit as recited in claim 11, wherein,
the brake disc comprises an internal toothing, and
the mounting element comprises an external toothing which is complementary to the internal toothing of the brake disc.

17. The wheel unit as recited in claim 11, wherein,
the clamping nut comprises anti-loss toothing on a side facing the mounting element,
the brake disc comprises anti-loss toothing on a side facing the clamping nut, and
the anti-loss toothing of the clamping nut interacts with the anti-loss toothing of the brake disc.

18. The wheel unit as recited in claim 11, further comprising:
a tool coupling structure,
wherein,
the clamping nut comprises a bore, and
the tool coupling structure is arranged on a circumferential surface of the bore or on an outer circumferential surface of the clamping nut.

19. The wheel unit as recited in claim 11, wherein.
the sensor ring has a center plane,
the brake disc has a center plane, and
the center plane of the sensor ring and the center plane of the brake disc are arranged to be offset relative to one another.

20. A pedelec comprising:
the wheel unit as recited in claim 11; and
a speed sensor which is configured to interact with the sensor ring of the wheel unit.
